(19) United States
(12) Patent Application Publication
(10) Pub. No.: US 2016/0151800 A1
(43) Pub. Date: Jun. 2, 2016

(54) HOLDER ASSEMBLY

(71) Applicant: Spiro Kosta, Eddystone, PA (US)

(72) Inventor: Spiro Kosta, Eddystone, PA (US)

(21) Appl. No.: 14/557,543

(22) Filed: Dec. 2, 2014

(51) Int. Cl. B05B 15/06; B05B 7/02

(52) U.S. Cl. CPC B05B 15/061; B05B 7/02

(57) ABSTRACT

A holder assembly includes a pole has an upper section and a lower section. An engaging member is coupled to the upper section. The engaging member may retain a paint gun on the pole. A connector is coupled to the pole such that the connector is positioned proximate a distal end of the pole with respect to the engaging member. A trigger is movably coupled to the connector. A cord extends between the paint gun and the trigger. The trigger may actuate the paint gun when the trigger is actuated.

### BACKGROUND OF THE DISCLOSURE

### Field of the Disclosure

The disclosure relates to holder devices and more particularly pertains to a new holder device for coupling a paint gun to an extension pole.

### SUMMARY OF THE DISCLOSURE

An embodiment of the disclosure meets the needs presented above by generally comprising a pole has an upper section and a lower section. An engaging member is coupled to the upper section. The engaging member may retain a paint gun on the pole. A connector is coupled to the pole such that the connector is positioned proximate a distal end of the pole with respect to the engaging member. A trigger is movably coupled to the connector. A cord extends between the paint gun and the trigger. The trigger may actuate the paint gun when the trigger is actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a left side view of a holder assembly according to an embodiment of the disclosure.

FIG. 2 is a front view of an embodiment of the disclosure.

FIG. 3 is a perspective view of an embodiment of the disclosure.

FIG. 4 is an in-use view of an embodiment of the disclosure.

### DESCRIPTION OF THE PREFERRED EMBODIMENT

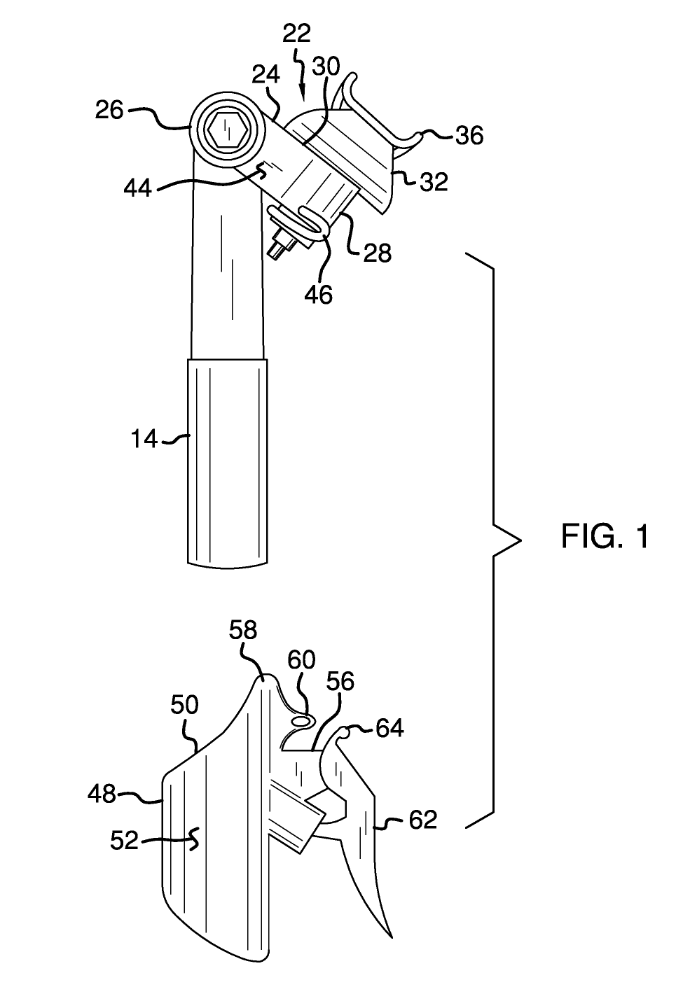

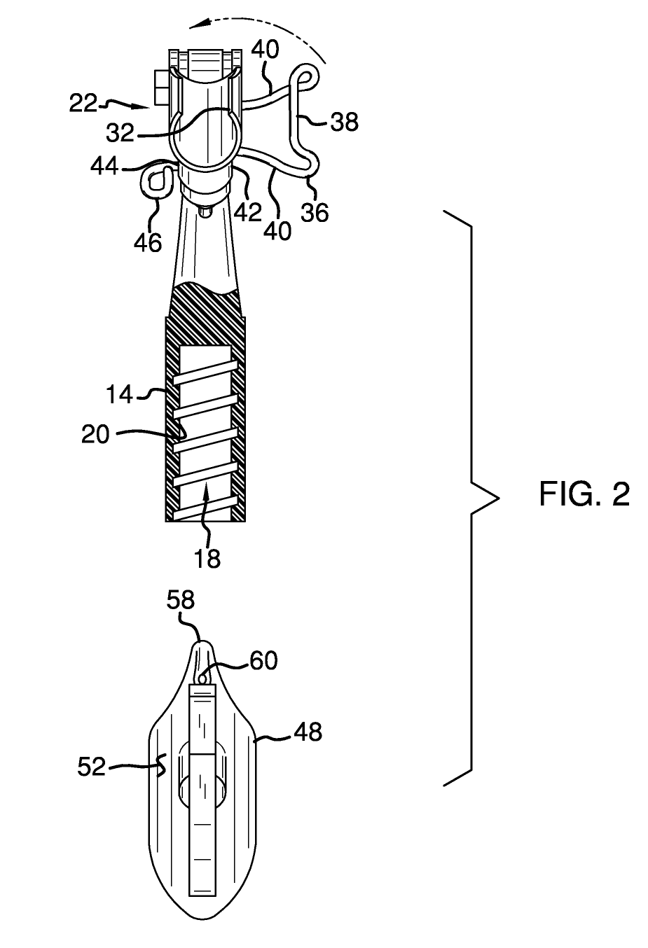

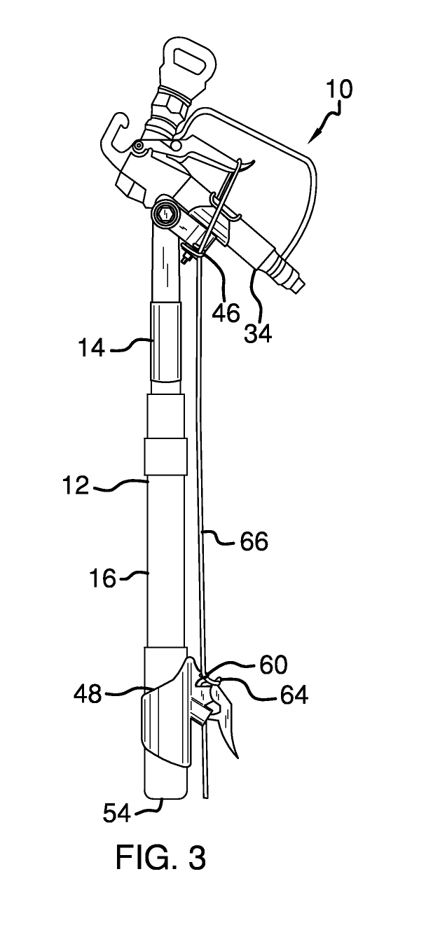

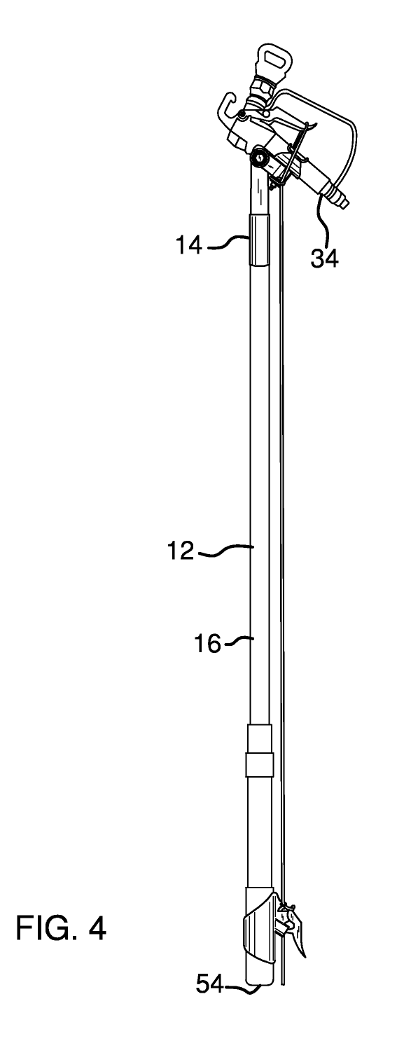

With reference now to the drawings, and in particular to FIGS. 1 through 4 thereof, a new holder device embodying the principles and concepts of an embodiment of the disclosure and generally designated by the reference numeral 10 will be described.

As best illustrated in FIGS. 1 through 4, the holder assembly 10 generally comprises a pole 12. The pole 12 has an upper section 14 and a lower section 16. The upper section 14 has a well 18 extending upwardly therein. A bounding surface 20 of the well 18 is threaded so upper section 14 may threadably engage the lower section 16. The lower section 16 has a telescopically adjustable length.

An engaging member 22 is provided. The engaging member 22 comprises a mount 24 that has a first end 26, a second end 28 and a top surface 30. The first end 26 is rotatably coupled to the upper section 14 such that the mount 24 is positionable at a selected angle with respect to the pole 12.

A saddle 32 is coupled to the top surface 30 of the mount 24. The saddle 32 may receive a paint gun 34 such that the paint gun 34 is retained on the pole 12. The paint gun 34 may be a pneumatic paint gun of any conventional design.

A clip 36 is provided. The clip 36 has a central section 38 and a pair of lateral sections 40 coupled to and extending away therefrom. The mount 24 has a first lateral surface 42 extending between the first 26 and second 28 ends. The clip 36 is movably coupled to the first lateral surface 42. The clip 36 is positionable in a closed position such that the clip 36 extends across the saddle 32 to retain the paint gun 34 within the saddle 32. The clip 36 is positionable in an open position such that clip 36 extends laterally away from the mount 24 to allow the paint gun 34 to be removed from the saddle 32.

The mount 24 has a second lateral surface 44 extending between the first 26 and second ends 28. A guide 46 is coupled to the second lateral surface 44 of the mount 24. The guide 46 is shaped into a pig-tail.

A connector 48 is provided. The connector 48 has an inner surface 50 and an outer surface 52. The connector 48 is coupled to the pole 12 such that the connector 48 is positioned proximate a distal end 54 of the pole 12 with respect to the engaging member 22. The connector 48 has a first tab 56 coupled to and extending outwardly from the outer surface 52. The connector 48 has a top edge 58. Additionally, the connector 48 has a loop 60 extending outwardly from the outer surface 52 such that the loop 60 is positioned proximate the top edge 58.

A trigger 62 is movably coupled to the first tab 56 on the connector 48. The trigger 62 has a second tab 64 coupled thereto. A cord 66 is coupled to and extends between the second tab 64 on the trigger 62 and the paint gun 34. The cord 66 extends through the loop 60 and the guide 46 to actuate the paint gun 34 when the trigger 62 is actuated.

In use, the lower section 16 of the pole 12 is adjusted to a selected length. The pole 12 is manipulated to position the paint gun 34 proximate an area that would otherwise be at an unreachable height. The trigger 62 is actuated, actuating the paint gun 34 to paint the area.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A holder assembly configured to retain a paint gun on an extension pole, said assembly comprising:
a pole having an upper section and a lower section;
an engaging member coupled to said upper section, said engaging member being configured to retain a paint gun on said pole;
a connector coupled to said pole such that said connector is positioned proximate a distal end of said pole with respect to said engaging member;
a trigger movably coupled to said connector; and
a cord extending between the paint gun and said trigger such that said trigger is configured to actuate the paint gun when said trigger is actuated.

2. The assembly according to claim 1, wherein said upper section having a well extending upwardly therein, a bounding surface of said well being threaded wherein said upper section threadably engages said lower section.

3. The assembly according to claim 2, wherein said engaging member comprising a mount having a first end, a second end and a top surface, said first end being rotatably coupled to said upper section such that said mount is positionable at a selected angle with respect to said pole.

4. The assembly according to claim 3, wherein a saddle coupled to said top surface of said mount, said first saddle being configured to receive the paint gun such that the paint gun is retained on said pole.

5. The assembly according to claim 2, wherein a clip having a central section and a pair of lateral sections coupled to and extending away therefrom, said mount having a first lateral surface extending between said first and second ends, said clip being movably coupled to said first lateral surface.

6. The assembly according to claim 1, further comprising:
a mount; and
a guide, said mount having a second lateral surface extending between said first and second ends, said guide being coupled to said second lateral surface of said mount.

7. The assembly according to claim 1, wherein:
a saddle; and
said clip being positionable in a closed position such that said clip extends across said saddle wherein said clip is configured to retain the paint gun within said saddle, said clip being positionable in an open position such that clip extends laterally away from said mount wherein said clip is configured to allow the paint gun to be removed from said saddle.

8. The assembly according to claim 1, wherein said connector having an inner surface, an outer surface and a top edge, said connector having a loop extending outwardly from said outer surface such that said loop is positioned proximate said top edge.

9. The assembly according to claim 1, wherein said trigger having a second tab coupled thereto.

10. The assembly according to claim 9, wherein:
a loop coupled to said connector;
a mount;
a guide coupled to a mount; and
said cord being coupled to said second tab on said trigger said cord extending through said loop and said guide.

11. A holder assembly configured to retain a paint gun on an extension pole, said assembly comprising:
a pole having an upper section and a lower section, said upper section having a well extending upwardly therein, a bounding surface of said well being threaded wherein said upper section threadably engages said lower section;
an engaging member, said engaging member comprising:
a mount having a first end, a second end and a top surface, said first end being rotatably coupled to said upper section such that said mount is positionable at a selected angle with respect to said pole;
a saddle coupled to said top surface of said mount, said saddle being configured to receive a paint gun such that the paint gun is retained on said pole;
a clip having a central section and a pair of lateral sections coupled to and extending away therefrom, said mount having a first lateral surface extending between said first and second ends, said clip being movably coupled to said first lateral surface, said clip being positionable in a closed position such that said clip extends across said saddle wherein said clip is configured to retain the paint gun within said saddle, said clip being positionable in an open position such that clip extends laterally away from said mount wherein said clip is configured to allow the paint gun to be removed from said saddle, and
a guide; said mount having a second lateral surface extending between said first and second ends, said guide being coupled to said second lateral surface of said mount;
a connector having an inner surface and an outer surface, said connector being coupled to said pole such that said connector is positioned proximate a distal end of said pole with respect to said engaging member, said connector having a first tab coupled to and extending outwardly from said outer surface, said connector having a top edge, said connector having a loop extending outwardly from said outer surface such that said loop is positioned proximate said top edge;
a trigger movably coupled to said connector, said trigger having a second tab coupled thereto; and
a cord coupled to and extending between said second tab on said trigger and the paint gun, said cord extending through said loop and said guide such that said trigger is configured to actuate the paint gun when said trigger is actuated.
